(19) United States
(12) Patent Application Publication
(10) Pub. No.: US 2020/0400618 A1
(43) Pub. Date: Dec. 24, 2020

(54) PAPER WARPING DETECTION DEVICE

(71) Applicant: Foxlink Image Technology Co., Ltd., New Taipei City (TW)

(72) Inventors: Ming Da Wu, New Taipei City (TW); Shih Sen Huang, New Taipei City (TW); Chang Yuan Wu, New Taipei City (TW)

(21) Appl. No.: 16/559,663

(22) Filed: Sep. 4, 2019

(30) Foreign Application Priority Data
Jun. 19, 2019 (TW) 108207768

(51) Int. Cl. G01N 29/07; B41J 11/00

(52) U.S. Cl. CPC G01N 29/075; B41J 11/009; B41J 11/006

(57) ABSTRACT

A paper warping detection device comprises: an input tray for loading a plurality of pieces of paper to be fed; a processor for storing a first threshold; a first emitting unit disposed at a front end of the input tray that forms a first angle with the input tray, and then emits a first ultrasonic beam toward the input tray in an obliquely and downward direction; a first receiving unit which is disposed at the front end of the input tray and formed a second angle with the input tray for receiving the ultrasonic beam reflected by the paper loaded in the input tray in a direction leaned downward; and a first analog to digital converter which is electrically connected to the first receiving unit and the processor respectively, for converting the reflected first ultrasonic beam received by the first receiving unit into a first digital signals and outputting the first digital signals to the processor.

### CROSS-REFERENCE TO RELATED APPLICATION

The present application is based on, and claims priority from, Taiwan Patent Application No. 108207768, filed Jun. 19, 2019, the disclosure of which is hereby incorporated by reference herein in its entirety.

### BACKGROUND OF THE INVENTION

### 1. Field of the Invention

The present invention relates to a detection device, and more particularly to a paper warping detection device capable of effectively detecting whether plurality pieces of paper are warped or not at the time of an uppermost piece of the paper being fed in.

### 2. The Related Art

Conventional business machines can be roughly classified into two types according to the document feeding mechanism: open style and closed style. The closed style document feeder is more suitable for accommodating large quantities of paper in one size. On the other hand, the open style document feeding mechanism such as the C-Type document feeder shown in FIG. 10A and the top-down document feeder shown in FIG. 10B has the advantages of easy to change paper and easy for troubleshooting. Therefore, it is widely used in a small but diverse personal model of printers and scanners, which is convenient for users to handle documents of different sizes and types.

However, the open style document feeders are limited by the characteristics of open structures and lack of space to set up sensors for detecting the status of the paper. Therefore, it is more difficult to stop the feeding process while paper jammed and cause damage to the paper.

Thus, it is essential to provide a paper warping detection device for open style document feeder which is capable of effectively detecting whether a plurality pieces of paper are warped or not at the time of an uppermost piece of the paper being fed in, so that the plurality pieces of the paper are prevented from being damaged at the time of the uppermost piece of the paper being fed in.

### SUMMARY OF THE INVENTION

An object of the present invention is to provide a paper warping detection device.

To achieve said objective, the paper warpage detecting device in this invention includes: an input tray for loading a plurality of pieces of paper to be fed; a processor for storing a first threshold; a first emitting unit disposed at a front end of the input tray that forms a first angle with the input tray, and then emits a first ultrasonic beam toward the input tray in an obliquely and downward direction; a first receiving unit which is disposed at the front end of the input tray and formed a second angle with the input tray for receiving the ultrasonic beam reflected by the paper loaded in the input tray in a direction leaned downward; and a first analog to digital converter which is electrically connected to the first receiving unit and the processor respectively, for converting the reflected first ultrasonic beam received by the first receiving unit into a first digital signals and outputting the first digital signals to the processor.

Wherein, the first angle is greater than the second angle, and the processor reads the first digital signals outputted by the first analog to digital converter and compares with the first threshold.

In another preferred embodiment, wherein said paper warping detection device further comprises: a second emitting unit disposed to one side of the input tray, the second emitting unit electrically connected with the processor for being controlled to switch on and off; a second receiving unit disposed to the other side of the input tray to face the second emitting unit for receiving the ultrasonic beam emitted by the second emitting unit; a second analog to digital converter electrically connected with the second receiving unit and the processor for converting the second ultrasonic beam received by the second receiving unit into a second digital signals and outputting the second digital signals to the processor, and the processor comparing the second digital signals with a second threshold stored in the processor; wherein, the second emitting unit comprises a transmitter and a first reflective wall which is configured as a spherical reflective wall, and aligns its concave side to the second receiving unit; and the transmitter is disposed to face the concave surface of the first reflective wall for collectively reflecting the projected second ultrasonic beam via the first reflective wall.

In another preferred embodiment, wherein the projection angle of the second emitting unit is set to less than 10 degrees.

In another preferred embodiment, wherein the first reflective wall is composed of a first curved wall and a second curved wall connected to the first curved wall, the first curved wall and the second curved wall both are a simple spherical reflecting wall and arranged to align the concave side to the second receiving unit; wherein the transmitter is disposed on the connection line of the focal point of the first curved wall and the focal point of the second curved wall, the first curved wall is disposed at the front side of the transmitter, and makes the center of curvature of the first curved wall disposed at the rear side of the transmitter; and the second curved wall is disposed at the rear side of the transmitter, and makes the center of curvature of the second curved wall disposed at the front side of the transmitter.

In another preferred embodiment, wherein the second receiving unit is composed of a receiver and a second curved wall, wherein the second curved wall is a spherical reflecting wall arranged to align the concave side to the first reflective wall, and the receiver is disposed at the concave surface of the second curved wall for collectively reflecting the second ultrasonic beam to the receiver via the second curved wall.

In another preferred embodiment, wherein the first receiving unit is arranged lower than the first emitting unit.

In another preferred embodiment, wherein the projection angle of the first ultrasonic beam of the first emitting unit is 94 degrees.

In another preferred embodiment, wherein the first angle is greater than 40 degrees and less than 60 degrees.

In another preferred embodiment, wherein the second angle is greater than 25 degrees and less than 45 degrees.

### BRIEF DESCRIPTION OF THE DRAWINGS

The present invention will be apparent to those skilled in the art by reading the following description, with reference to the attached drawings, in which:

FIG. 1 is a top view of a paper warping detection device in accordance with a preferred embodiment of the present invention;

FIG. 2 is a right view of the paper warping detection device of FIG. 1;

FIG. 3 is a diagrammatic drawing of an abnormal paper feeding status of the paper warping detection device of FIG. 2, wherein a pick roller of the paper warping detection device picks up an uppermost piece of paper and drives the uppermost piece of paper;

FIG. 4 is a diagrammatic drawing of the abnormal paper feeding status of the paper warping detection device of FIG. 2, wherein leading ends of the plurality of pieces of the paper to occur warping deformations after the pick roller picks up the uppermost piece of paper;

FIG. 5 is a block diagram of the paper warping detection device in accordance with the present invention;

FIG. 6A is a top view of the second emitting unit in accordance with a preferred embodiment of the present invention;

FIG. 6B is a top view of the second emitting unit in accordance with another preferred embodiment of the present invention;

FIG. 7A shows the projection angle of the ultrasonic beam emitted by the second emitting unit in accordance with a preferred embodiment of the present invention;

FIG. 7B shows the projection angle of the ultrasonic beam emitted by the second emitting unit in accordance with another preferred embodiment of the present invention;

FIG. 7C shows the projection angle of the ultrasonic beam received by the second receiving unit in accordance with a preferred embodiment of the present invention;

FIG. 8A is a diagrammatic drawing of the relative position of the first emitting unit and the input tray;

FIG. 8B is a diagrammatic drawing showing that the paper reflects the ultrasonic beam emitted by the first emitting unit;

FIG. 8C is a diagrammatic drawing showing that the paper reflects the ultrasonic beam while the angle between the first emitting unit and the input tray is too small;

FIG. 8D is a diagrammatic drawing showing that the paper reflects the ultrasonic beam while the angle between the first emitting unit and the input tray is too large;

FIG. 9A is a diagrammatic drawing showing that the angle between the first receiving unit and the input tray is too small;

FIG. 9B is a diagrammatic drawing showing that the angle between the first receiving unit and the input tray is too large;

FIG. 10A is a perspective view of a conventional business machine with open style document feeder;

FIG. 10A is a perspective view of another conventional business machine with open style document feeder.

### DETAILED DESCRIPTION OF THE PREFERRED EMBODIMENT

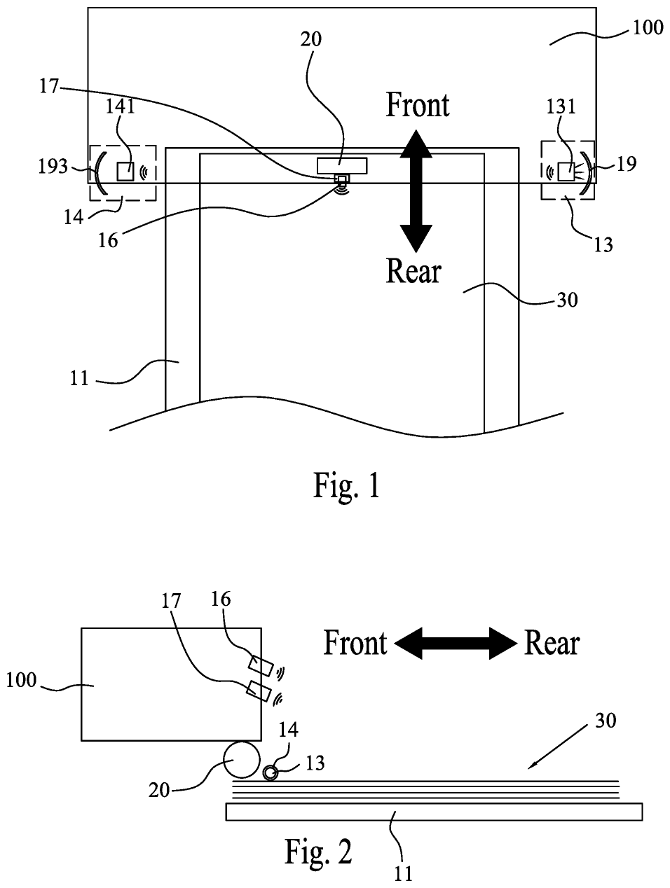

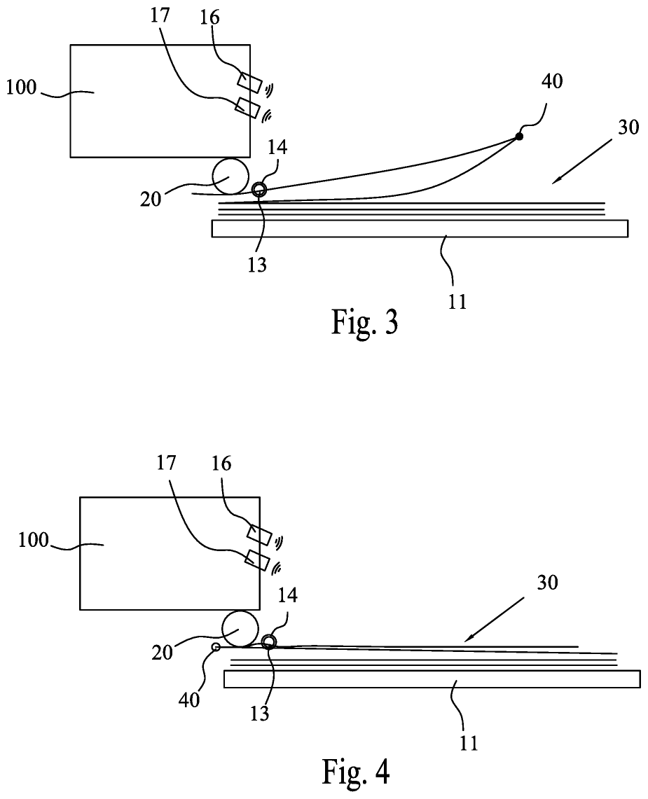

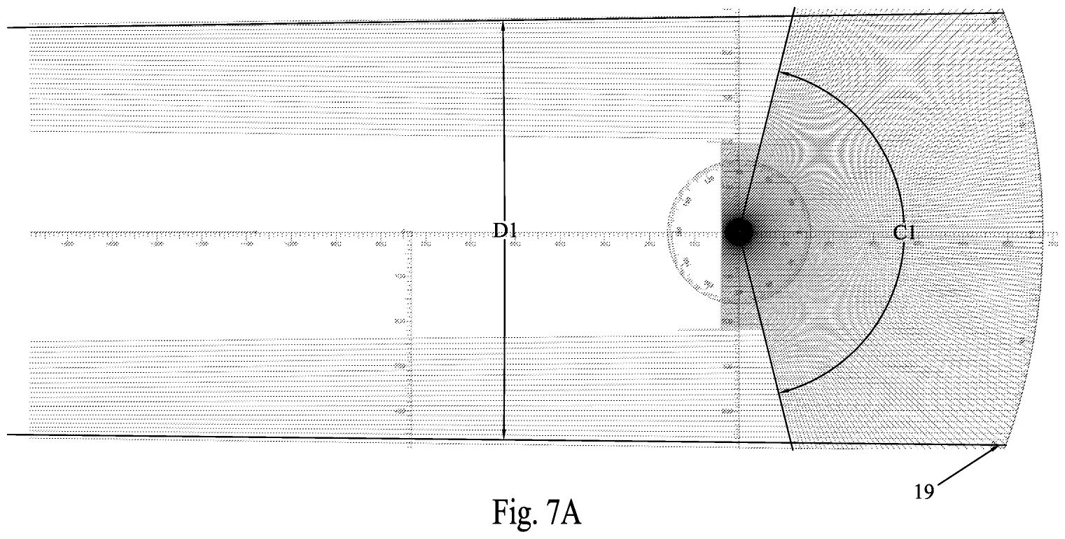

With reference to FIG. 1, FIG. 2 and FIG. 5, a paper warping detection device 100 in accordance with the present invention is shown. The paper warping detection device 100 is assembled in a transaction device such as a printer or a scanner etc. The paper warping detection device 100 applying a paper warping detection method, includes an input tray 11, a processor 12, a second emitting unit 13, a second receiving unit 14, a second analog to digital converter 15, a first emitting unit 16, a first receiving unit 17, a first analog to digital converter 18, a first reflective wall 19 and a pick roller 20.

When describing the paper warping detection device 100, the relative position of the paper warping detection device 100 to the transaction device is merely exemplary and does not limit the scope of the present invention. The principle of the present invention can also apply to the top-down type document feeder and the C-Type document feeder. Moreover, the principles of the present invention can be achieved on horizontal and inclined document feeder. As the preferred embodiment shown in FIG. 1, the input tray 11 is placed horizontally, and papers 30 to be fed are placed on the input tray 11 in a stacked manner. One end of the input tray 11 is connected to a feeding path and the pick roller 20. For the convenience of description, the end of the input tray 30 that is adjacent to the pick roller 20 is defined as the front end and the end which is away from the pick roller 20 is defined as the rear end in the rest of the present specification, and the words “front” and “rear” in this specification are also used to described the direction that points from the rear end to the front end and the direction that points from the front end to the rear end. Therefore, the paper 30 is driven by the pick roller 20 to move from the rear end to the front end of the input tray 11, and into the feeding path in the end.

The second emitting unit 13 and the second receiving unit 14 are respectively disposed on both lateral sides of the front end of the input tray 11. The processor 12 which stores a second threshold is electrically connected to the second emitting unit 13. The processor 12 controls the switch of the second emitting unit 13. The second emitting unit 13 emits a second ultrasonic beam across the upper surface of the paper 30 while turned on, and the second ultrasonic beam is received by the second receiving unit 14 disposed on the opposite side of the input tray 11. The second analog to digital converter 15 is electrically connected to the second receiving unit 14 and the processor 12 respectively for converting the second ultrasonic beam received by the second receiving unit 14 into a second digital signals and outputting it to the processor 12. The processor 12 reads the second digital signals output by the second analog to digital converter 15 and compares it with the second threshold.

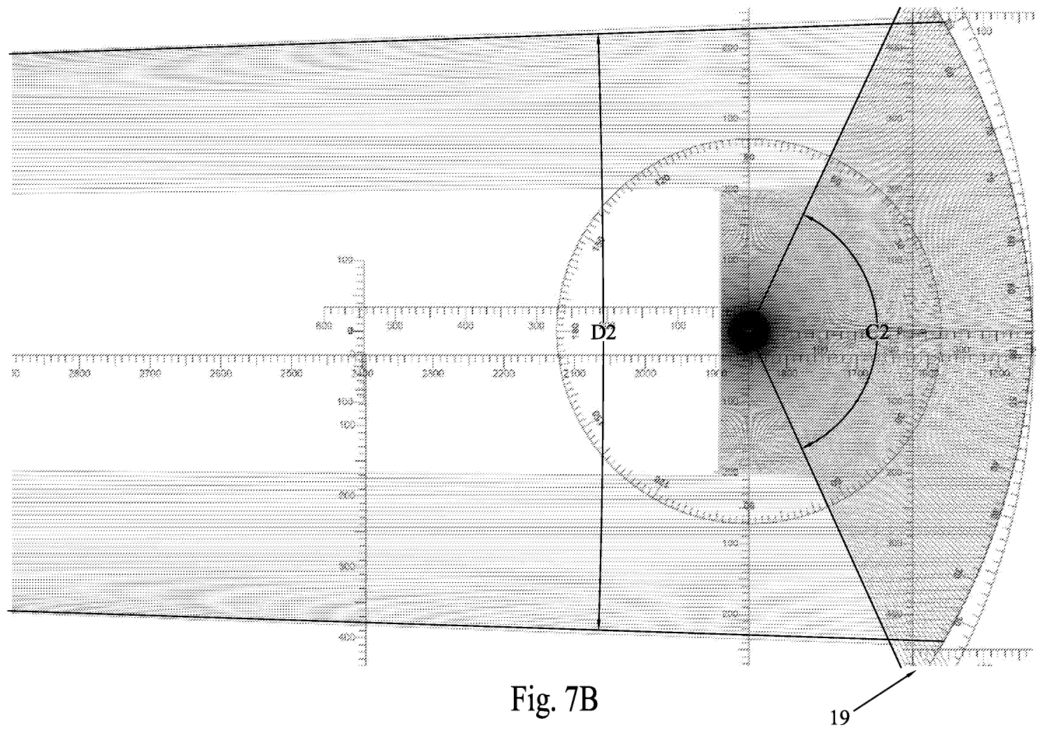

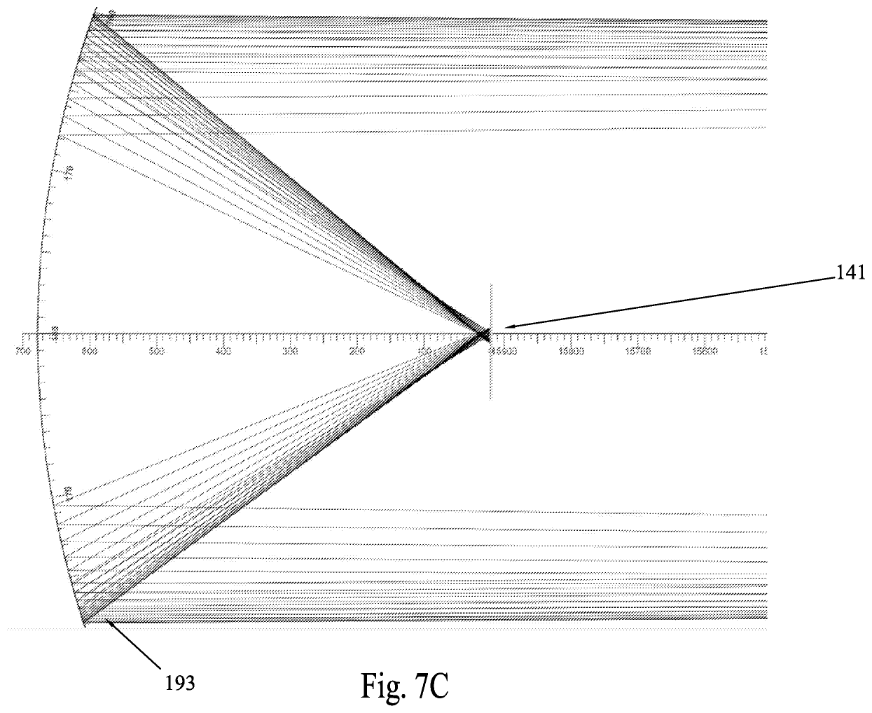

Referring to FIG. 1, FIG. 6A and FIG. 7A, in order to improve the effect of detecting paper, the projection angle of the second ultrasonic beam emitted by the second emitting unit 13 is better to be set less than 10 degrees, and the optimum angle of the projection angle is preferably 0 degrees. And to make the projection angle of the second emitting unit 13 less than 10 degrees, in the preferred embodiment shown in FIGS. 6A and 7A, the second emitting unit 13 includes a transmitter 131 and a first reflective wall 19, wherein the first reflective wall 19 is a spherical reflective wall, and the concave surface of the spherical reflective wall faces the second receiving unit 14; the transmitter 131 is disposed to face the concave surface of the first reflective wall 19 for collectively reflecting the projected second ultrasonic beam via the first reflective wall 19. As shown in FIG. 7A, after the reflection of the first reflective wall 19, the projection angle of the second ultrasonic beam projected from transmitter 131 is remarkably reduced from C1 to D1.

Referring to FIG. 6B and FIG. 7B. In order to further reduce the width W of the second emitting unit 13, the first reflective wall 19 shown in this preferred embodiment is formed with a first curved wall 191 and a second curved wall 192. The first curved wall 191 and the second curved wall 192 are both simple spherical reflecting walls and disposed to align the concave sides of the first curved wall 191 and the second curved wall 192 to the second receiving unit 14, and the transmitter 131 is disposed on the connected line that connects the focal points f1 of the first curved wall 191 and the focal point f2 of the second curved wall 192. Wherein the first curved wall 191 is disposed at the front side of the transmitter 131, and makes the center of curvature of the first curved wall 191 disposed at the rear side of the transmitter 131; and the second curved wall 192 is disposed at the rear side of the transmitter 131, and makes the center of curvature of the second curved wall 192 disposed at the front side of the transmitter 131. With said arrangements, the curvature radius of the first reflective wall 19 is reduced, and thus reduces the distance between the transmitter 131 and the first reflective wall 19 and the width (W) of the second emitting unit 13. As shown in FIG. 7B, after the reflection of the first reflective wall 19, the projection angle of the second ultrasonic beam projected from the transmitter 131 is remarkably reduced from C2 to D2.

In the preferred embodiment shown in FIG. 1 and FIG. 7C, the second receiving unit 14 includes a receiver 141 and a second reflective wall 193, the second reflective wall 193 is a spherical reflecting wall, and a concave side of the spherical reflecting wall faces the second transmitting unit 13; and the receiver 141 is disposed to face the concave surface of the second reflective wall 193 for collectively reflecting the second ultrasonic beam to the receiver 141 via the second reflective wall 193. As shown in FIG. 7C, the second ultrasonic beam projected from the transmitter 131 is concentrated to the receiver 141 after being reflected by the second reflective wall 193.

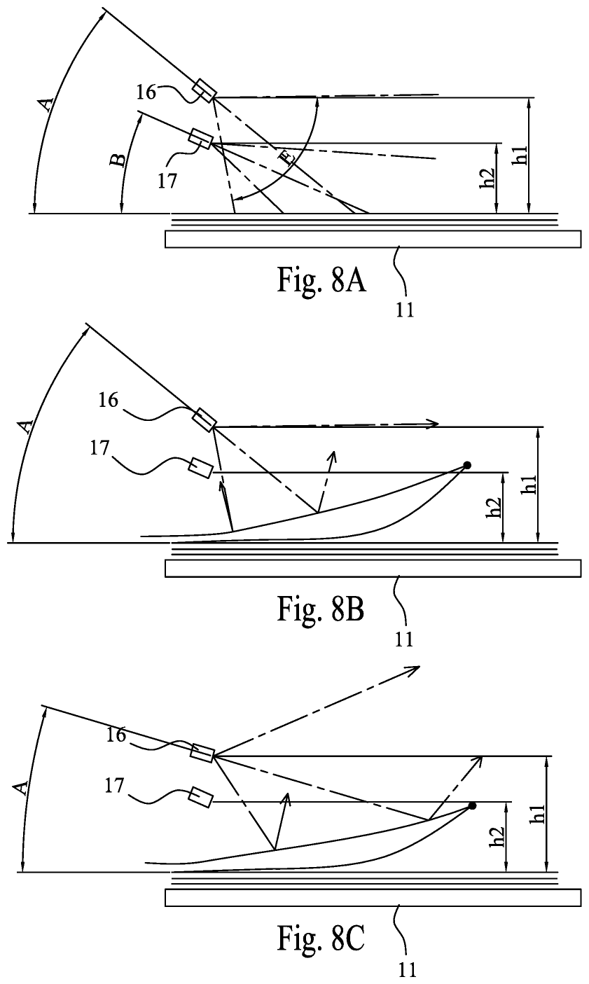

Referring to FIG. 1, FIG. 8A and FIG. 5, the processor 12 further stores a first threshold, and the first emitting unit 16 is also disposed at the front end of the input tray 11 and emits the ultrasonic beam toward the rear end of the input tray. As shown in FIG. 8A, the first emitting unit 16 forms a first angle A with the input tray 11 and emits a first ultrasonic beam in an inclined and downward direction. Wherein, the first emitting unit 16 is electrically connected to the processor 12, and the processor 12 controls the switch of the first emitting unit 16. The first emitting unit 16 emits the first ultrasonic beam downward and forward to the upper surface of the paper 30 while turned on. The first receiving unit 17 is disposed at the front end of the input tray 11 and forms a second angle B with the input tray 11, and thus receives the first ultrasonic beam reflected by the paper 30 in a direction forward and downward. Wherein, The first angle (A) between the first emitting unit 16 and the input tray 11 is greater than the second angle (B) between the first receiving unit 17 and the input tray 11, and the height (h2) of the first receiving unit 17 is set lower than the height (h1) of the first emitting unit 16. The first analog to digital converter 18 is electrically connected to the first receiving unit 17 for converting the first ultrasonic beam received by the first receiving unit 17 into first digital signals and outputting the first digital signals. The first analog to digital converter 18 is also electrically coupled to the processor 12, and the processor 12 reads the first digital signals outputted by the first analog to digital converter 18 and compares the first digital signals with the first threshold.

Referring to FIG. 8A, in order to make the ultrasonic beam cover the entire input tray 11, the projection angle (E) of the first emitting unit 16 is greater than 60 degrees. However, the spreading of the ultrasonic beam would weaken the signal strength, and to avoid the ultrasonic beam being spread too wide, the projection angle (E) is limited to be less than 100 degrees, and for the best performance, the projection angle (E) of the first emitting unit 16 is 94 degrees. Referring to FIG. 8B, the first angle (A) between the first emitting unit 16 and the input tray 11 will also affect the effect of detecting the warpage of the paper 30, and thus, the first angle (A) shown in FIG. 8B is set to be greater than 40 degrees and less than 60 degrees to improve the detecting effect. In this case, the first ultrasonic beam reflected by the warpage of paper can easily reaches the first receiving unit 17, and thus improves the effect of detecting the slight warp at the end of the paper.

However, if the angle (A) being set too small such as shown in FIG. 8C, the first emitting unit 16 and the input tray 11 tends to be parallel, and so does the first ultrasonic beam emitted by the first emitting unit 16. In this case, the ultrasonic beam is more likely to be reflected toward the rear end of the input tray 11 and cannot be received by the first receiving unit 17. Furthermore, it also makes the covering area of the first ultrasonic beam lean backward to the rear end of the input tray 11 and causes the warpage of shorter paper undetectable.

If the angle (A) being set too large such as shown in FIG. 8D, the first emitting unit 16 and the input tray 11 tends to be perpendicular, and makes the covering area of the first emitting unit 16 smaller. To enlarge the covering area of the first emitting unit 16, the distance (h1) between the first emitting unit 16 and the input tray 11 needs to be increased, and that makes the production cost increased. Furthermore, tilts the first emitting unit 16 more perpendicular to the input tray 11 will also make the coving area of the ultrasonic beam leaned to the front end of the input tray 11 and cause the warpage at the rear end of paper undetectable, which will result in insufficient reaction time after detecting the error.

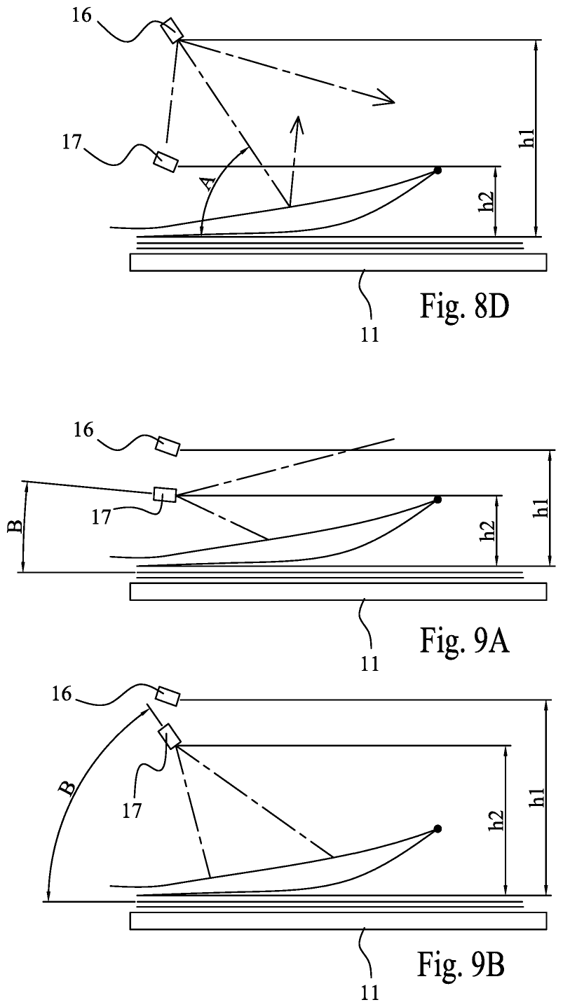

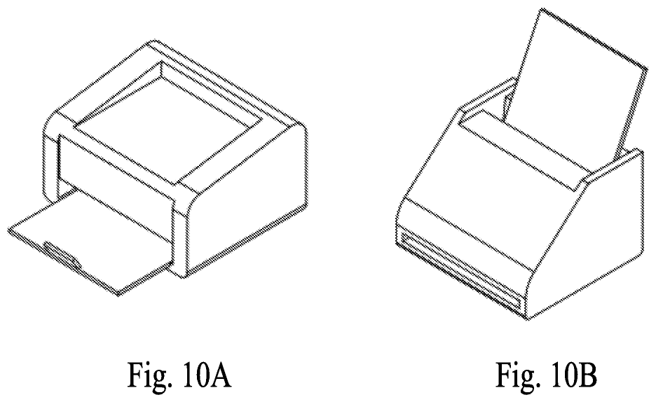

Referring to FIG. 9A and FIG. 9B, the second angle (B) between the first receiving unit 17 and the input tray 11 also affects the effect of detecting the warpage of the paper 30. As shown in FIG. 9A, when the second angle (B) between the first receiving unit 17 and the input tray 11 is too small, it will receive the first ultrasonic beam reflected by objects other than the paper 30 and cause an error. Referring to FIG. 9B, when the second angle (B) between the first receiving unit 17 and the input tray 11 is too large, the range of receiving the first ultrasonic beam will shift to the front end of the input tray 11, which may cause the warpage of paper can only be detected very close to the pick roller 20, so that the reaction time after detecting the error is insufficient, besides, the distance (h2) between the first receiving unit 17 and the input tray 11 also needs to be increased to ensure the receiving area of the first receiving unit 17 covers the entire input tray 11, which will further increase the production cost. Furthermore, the second angle (B) between the first receiving unit 17 and the input tray 11 is greater than 25 degrees and less than 45 degrees.

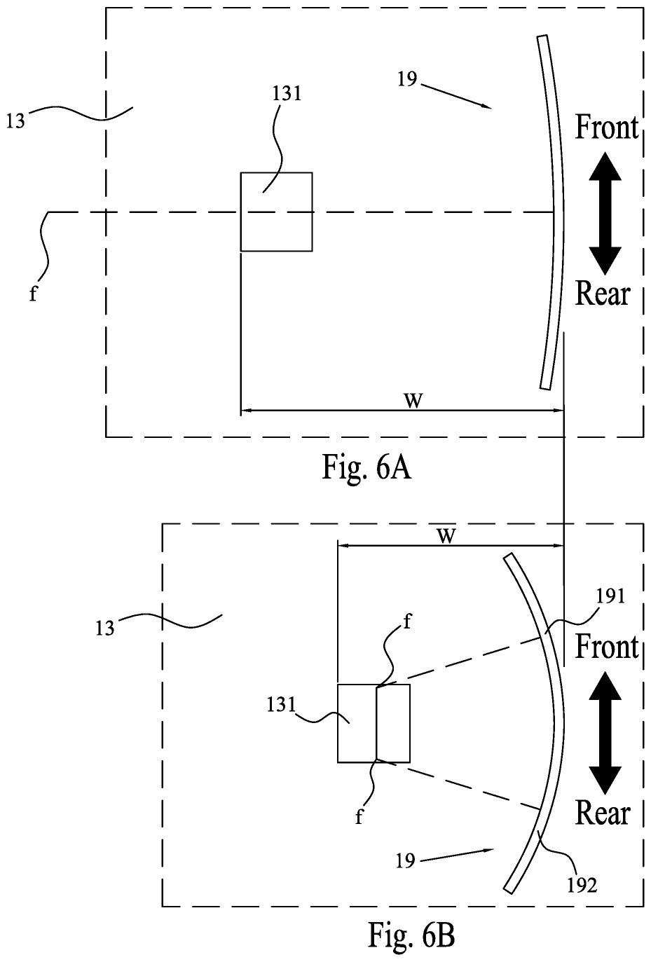

Referring to FIG. 1, FIG. 2, FIG. 4 and FIG. 5 now, the methods of detecting warpage of papers of the present invention includes the following steps:

Step S1: emitting a second ultrasonic beam with the second emitting unit 13 to across the front end of the top surface of the uppermost piece of the paper 30.

Step S2: receiving the second ultrasonic beam with the second receiving unit 14.

Step S3: converting the second ultrasonic beam into a second digital signals with the second analog to digital converter 15, the second digital signals are outputted to the processor 12 by the second analog to digital converter 15.

Step S4: storing the second threshold in the processor 12, reading the second digital signals and comparing the second digital signals with the second threshold with the processor 12, when a strength of the second digital signals outputted by the second analog to digital converter 15 is less than the second threshold, the paper 30 is judged to be warped at the time of the uppermost piece of paper 30 being fed in, and the plurality of pieces of paper 30 are stopped being fed in, on the contrary, the paper is judged to be normally fed at the time of the uppermost piece of paper 30 is fed in.

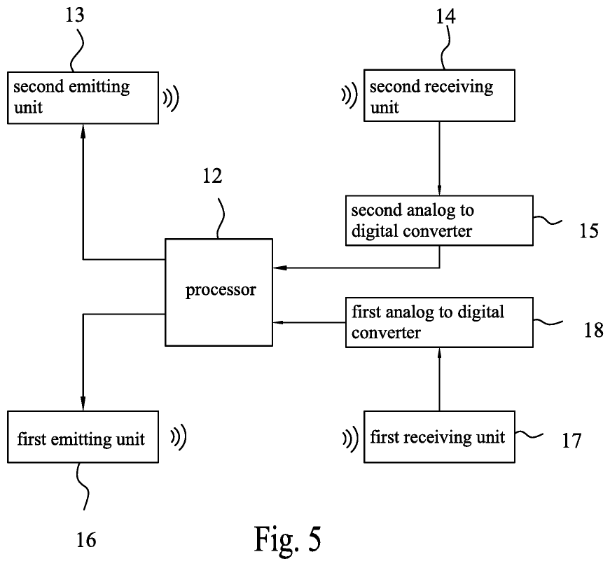

With reference to FIG. 1, FIG. 2, FIG. 3 and FIG. 5, the paper warping detection method applied in the paper warping detection device 100 further includes the following steps.

Step S21: emitting the first ultrasonic beam towards frontward and downward to the top surface of the uppermost piece of paper 30 with the first emitting unit 16, the first ultrasonic beam is reflected by the uppermost piece of paper 30.

Step S22: receiving the reflected first ultrasonic beam with the first emitting unit 17.

Step S23: converting the reflected first ultrasonic beam into the first digital signals with the first analog to digital converter 18, the first digital signals are outputted to the processor 12 by the first analog to digital converter 18.

Step S24: storing the first threshold in the processor 12, reading the first digital signals and comparing the first digital signals with the first threshold with the processor 12, when a strength of the first digital signals is greater than the first threshold, the uppermost piece of paper 30 is judged to be warped at the time of the uppermost piece of paper 30 is fed in, and the plurality of pieces of paper 30 are stopped being fed in, on the contrary, the uppermost piece of paper 30 is judged to be normally fed at the time of the uppermost piece of paper 30 is fed in.

Referring to FIG. 1 to FIG. 5, a working principle of the paper warping detection device 100 applying the paper warping detection method is described as follows. When the uppermost piece of paper 30 is picked up, the pick roller 20 moves downward until the pick roller 20 abuts against the top surface of the uppermost piece of paper 30 loaded on the input tray 11. When the pick roller 20 picks up the uppermost piece of paper 30 and drives the uppermost piece of paper 30 to be fed normally, the second receiving unit 14 receives the stronger and more stable second ultrasonic beam.

In a status that leading ends of the plurality of pieces of paper 30 to be fed are stapled by a staple 40. When the pick roller 20 rotates and drives the uppermost piece of paper 30 to be normally fed forward, at the moment, the leading end of the uppermost piece of paper 30 will occur a warping deformation. A warping portion of the uppermost piece of paper 30 will block the second receiving unit 14 from receiving the second ultrasonic beam emitted by the second emitting unit 13, and weaken the second ultrasonic beam received by the second receiving unit 14 or completely block out the second ultrasonic beam. When the strength of the second ultrasonic beam received by the second receiving unit 14 is less than the second threshold, namely the uppermost piece of paper 30 is judged to be warped at the time of the uppermost piece of paper 30 being fed in, the plurality of pieces of paper 30 are stopped being fed in, so that the plurality of pieces of paper 30 are effectively prevented from being damaged at the time of the uppermost piece of paper 30 is fed in.

In a status that rear ends of the plurality of pieces of paper 30 are stapled by another staple 40, when the pick roller 20 picks up the uppermost piece of paper 30, and drives the uppermost piece of paper 30 forward, the uppermost piece of paper 30 will drag all of paper 30 which are stapled together and makes the rear ends of all paper 30 warped upward, and thus blocks out the second ultrasonic beam emitted by the second emitting unit 13, in this case, the paper warping caused by stapled at the rear end can be detected by means of the step S21 to the step S24 in the paper warping detection method. However, if the paper 30 is stapled at the front end, the steps of detection method S21 to S24 might not be fast enough to avoid damage (the leading end of the paper 30 only blocks out the second ultrasonic beam emitted by the second emitting unit 13 when the rear ends of the plurality of pieces of paper 30 are warped to the certain extent, thus it would be too late to detect the paper warping), at the moment, the rear ends of the plurality of pieces of paper 30 are even warped to the leading ends of the plurality of pieces of paper 30, and the paper 30 are apt to be damaged. Thus, it would be more efficient to combine the step S1 to S4 with the following steps S21 to S24, to prevent the paper 30 from being damaged at the time of the uppermost piece of paper 30 is fed in.

The working principle of the steps S21 to S24 of the paper warping detection method are described as follow. When the uppermost piece of paper 30 is fed normally, the first receiving unit 17 cannot receive the first ultrasonic beam reflected by the paper 30 or receives only very weak first ultrasonic beam due to the reflected first ultrasonic beam are mostly reflected toward the rear end. However, when the front ends of the plurality of pieces of paper 30 are stapled by the staple 40, the uppermost piece of paper 30 will be deformed at the front end under the driving force from the pick roller 20 and the drag force applied by the rest of the plurality of pieces of paper 30 that stapled together. With the deformation, the first ultrasonic beam emitted by the first emitting unit 16 will be reflected back to the front end of the input tray 11, so the first receiving unit 17 is capable of receiving the stronger first ultrasonic beam. When the strength of the first ultrasonic beam received by the first receiving unit 17 is greater than the first threshold, namely the uppermost piece of paper 30 is judged to be warped at the time of the uppermost piece of paper 30 being fed in, so that the plurality of pieces of paper 30 are effectively prevented from being damaged at the time of the uppermost piece of paper 30 is fed in.

As described above, when the leading end of the uppermost piece of paper 30 occurs the warping deformation, the uppermost piece of paper 30 is judged to be warped at the time of the uppermost piece of paper 30 is fed in, and in addition, when the rear ends of the plurality of pieces of paper 30 are warped upward to the certain extent, the plurality of pieces of paper 30 are capable of being detected to be warped, the uppermost piece of paper 30 is stopped being fed in. As a result, the paper warping detection device 100 applying the paper warping detection method is capable of effectively detecting whether the plurality of pieces of paper 30 are warped or not at the time of the uppermost piece of paper 30 being fed in, so that the plurality of pieces of paper 30 are effectively prevented from being damaged at the time of the uppermost piece of paper 30 is fed in.

What is claimed is:

1. A paper warping detection device comprising:
an input tray for loading a plurality of pieces of paper to be fed;
a processor for storing a first threshold;
a first emitting unit disposed at a front end of the input tray that forms a first angle with the input tray, and then emits a first ultrasonic beam toward the input tray in an obliquely and downward direction;
a first receiving unit which is disposed at the front end of the input tray and formed a second angle with the input tray for receiving the ultrasonic beam reflected by the paper loaded in the input tray in a direction leaned downward; and
a first analog to digital converter which is electrically connected to the first receiving unit and the processor respectively, for converting the reflected first ultrasonic beam received by the first receiving unit into a first digital signals and outputting the first digital signals to the processor;
wherein, the first angle is greater than the second angle, and the processor reads the first digital signals outputted by the first analog to digital converter and compares with the first threshold.

2. The paper warping detection device as claimed in claim 1, further comprising:
a second emitting unit disposed to one side of the input tray, the second emitting unit electrically connected with the processor for being controlled to switch on and off;
a second receiving unit disposed to the other side of the input tray to face the second emitting unit for receiving the ultrasonic beam emitted by the second emitting unit;
a second analog to digital converter electrically connected with the second receiving unit and the processor for converting the second ultrasonic beam received by the second receiving unit into a second digital signals and outputting the second digital signals to the processor, and
the processor comparing the second digital signals with a second threshold stored in the processor;
wherein, the second emitting unit comprises a transmitter and a first reflective wall which is configured as a spherical reflective wall, and aligns its concave side to the second receiving unit; and the transmitter is disposed to face the concave surface of the first reflective wall for collectively reflecting the projected second ultrasonic beam via the first reflective wall.

3. The paper warping detection device as claimed in claim 2, wherein the projection angle of the second emitting unit is set to less than 10 degrees.

4. The paper warping detection device as claimed in claim 2, wherein the first reflective wall is composed of a first curved wall and a second curved wall connected to the first curved wall, the first curved wall and the second curved wall both are a simple spherical reflecting wall and arranged to align the concave side to the second receiving unit; wherein the transmitter is disposed on the connection line of the focal point of the first curved wall and the focal point of the second curved wall, the first curved wall is disposed at the front side of the transmitter, and makes the center of curvature of the first curved wall disposed at the rear side of the transmitter; and the second curved wall is disposed at the rear side of the transmitter, and makes the center of curvature of the second curved wall disposed at the front side of the transmitter.

5. The paper warping detection device as claimed in claim 2, wherein the second receiving unit is composed of a receiver and a second curved wall, wherein the second curved wall is a spherical reflecting wall arranged to align the concave side to the first reflective wall, and the receiver is disposed at the concave surface of the second curved wall for collectively reflecting the second ultrasonic beam to the receiver via the second curved wall.

6. The paper warping detection device as claimed in claim 1, wherein the first receiving unit is arranged lower than the first emitting unit.

7. The paper warping detection device as claimed in claim 1, wherein the projection angle of the first ultrasonic beam of the first emitting unit is 94 degrees.

8. The paper warping detection device as claimed in claim 1, wherein the first angle is greater than 40 degrees and less than 60 degrees.

9. The paper warping detection device as claimed in claim 1, wherein the second angle is greater than 25 degrees and less than 45 degrees.
